(19) United States
(12) Patent Application Publication
(10) Pub. No.: US 2022/0070215 A1
(43) Pub. Date: Mar. 3, 2022

(54) Method and Apparatus for Evaluating Phishing Sites to Determine Their Level of Danger and Profile Phisher Behavior

(71) Applicants: Salvatore J. Stolfo, New York, NY (US); Shlomo Hershkop, Philadelphia, PA (US)

(72) Inventors: Salvatore J. Stolfo, New York, NY (US); Shlomo Hershkop, Philadelphia, PA (US)

(21) Appl. No.: 17/462,585

(22) Filed: Aug. 31, 2021

Related U.S. Application Data
(60) Provisional application No. 63/073,443, filed on Sep. 1, 2020.
(60) Provisional application No. 63/072,892, filed on Aug. 31, 2020.

(51) Int. Cl. H04L 29/06

(52) U.S. Cl. CPC H04L 63/1483; H04L 63/1491

(57) ABSTRACT

Enhanced attribution of phishers and assessment of the danger level posed by phishing campaigns by applying machine learning techniques to analyze the contents of phishing websites. The danger level may be determined as a function of the amount and kind of sensitive personal information the site attempts to steal. Profiling phisher behavior may be used as advanced threat intelligence to help predict targeted website for spoofing and/or phishing campaigns. Profiling phisher behavior may be accomplished by a focused analysis of the displayed items or words generated by the code with which the phisher labels webform input fields across different websites. The model of phisher behavior may reveal a phisher's motive and intent and may be used to investigate organized phishing teams. Rating phishing sites may inform response strategies and provide more informed critical browser messaging to the user.

### CROSS-REFERENCE TO RELATED APPLICATIONS

This application claims the benefit of U.S. Provisional Patent Application No. 63/072,892, filed on Aug. 31, 2020, and U.S. Provisional Patent Application No. 63/073,443, filed on Sep. 1, 2020. The entire contents of these applications are incorporated herein by reference.

### BACKGROUND OF THE INVENTION

Cyber criminals use phishing techniques to attack computer systems and monetize stolen digital identity information. Customers of retail websites, such as Amazon.com, are frequent targets of phishers. According to some reports, 90% of computer system breaches are due to successful phishing campaigns. Some attackers have automated the phishing process by automating registrations of new domains and by using site creation tools, such as Httrack, that copy and spoof legitimate websites wholesale in minutes.

Stolen identify information may provide access to a victim's online accounts. Certain kinds of Personally Identifiable Information (PII) are particularly sensitive, the theft of which could lead to very significant identity loss and substantial financial damage to an individual victim. Although various reports estimate the per person financial loss due to identity theft is $1,500, havoc can be wreaked due to time lost in resolving an incident, possible legal actions and arrest, lower credit scores that may never recover, and the emotional stress incurred by the victim. For the year 2019, the FTC reported well over 2.3 million reported cases with total losses in the billions of dollars. Identity theft is a growing problem, and a most people now rightfully take privacy and their identity information quite seriously.

Every browser and major service provider provides some level of spam filtering to reduce the success of phishing emails reaching users. Telecom companies are beginning to recognize Smishing, a form of phishing that uses mobile phones as the attack platform, is growing in intensity and some amount of filtering may be necessary for text messages. Operators of corporate networks have deployed a number of defensive strategies and products to combat phishing. Most solutions are aimed at enterprise employees. Web and email filtering, driven by reputation and threat intel, largely reduce the influx of malicious links that lure victims to spoof sites and trick them into providing their corporate login credentials.

Domain monitoring services provide valuable information identifying likely malicious sites, but attackers increasingly find easy ways to evade detection. For example, spoof sites may be buried within legitimate domains. No amount of domain registry analysis can find these sites. A recent study shows domain monitoring is only effective at detecting 28% of phishing sites.

No industry sector is immune from the attention of phishers. It is no wonder that most organizations invest in training to improve employee awareness. These prevention techniques may help to reduce the success of phishing attacks seeking to infiltrate corporate security boundaries. However, these techniques are insufficient when customers of an enterprise are phi shed in the same manner. Corporate employees have corporate security architectures that inspect their web traffic and emails, but no such monitoring and protection exists for customers. A company's customers are external to the corporate network, use various email servers, and use their devices to connect to the company's website or customer portal. This makes them soft targets.

To decrease the likelihood a user will fall prey to phishing, Google is announced a feature of its Chrome86 browser which truncates the URL displayed to users, revealing only the domain name. Unfortunately, text message delivery of phishing URL's is on the rise, and URL truncation through a browser won't cover this case. Nor will such methods abate phishing attacks targeting cloud services, such as AWS. Furthermore, it remains to be seen what conflicts might arise when legitimate companies link to third party providers which may cause confusion by customers.

### SUMMARY OF THE INVENTION

The present invention provides advanced threat intelligence of the danger posed by a phishing web site, and the profiling of phishers or teams of phishers who are likely to use and reuse infrastructures, or tools for phishing.

The present invention facilitates the automatic acquisition of ground truth data about malicious attackers based upon their own code base and tools used in large collections of phishing sites, and the automatic evaluation of the level of danger posed by a phishing site based upon, for example, the kind of PII the site attempts to steal from an unwitting victim. The evaluation metrics may be presented as, for example, three distinct levels of danger, or may be extended to finer granularity depending upon context. Profiling attacker behaviors has tremendous value as advanced threat intel for defenders seeking fast detection of likely adversary threats. Detailed profiles of the code within each phishing website may be developed to identify clusters of different websites likely created by the same phisher, or phishing team. The analysis may be greatly simplified by focusing entirely on input variable names and terms displayed to the user. This provides insight into the number of distinct phishers in the dataset, and provides data for longitudinal studies, and data for predictive analysis of what phishers do over time.

It is an object of the present invention to evaluate or rate the level of danger/malice associated with a phishing website based upon the website content elements such as: (1) the kind of PII information it attempts to steal from victim visitors to the site; (2) the visual presentation to the user like branding to mimic trusted sources (titles, logos, colors, layouts); (3) the context of the call to action (reset account, warning) requiring the user to act before they can think; (4) whether the website is part of a multi-step campaign, such as a message in a website that someone will call the user later in perhaps a Vishing activity (the use of telephony to conduct phishing attacks); (5) whether the site drops malicious content or cookies on the user's machine.

Another object of the present invention is to identify the specific information a phishing site attempts to steal from a victim, and to generate deceptive or decoy information to provide what appears to be believable but entirely bogus data. Note that The “stuffing” of decoy data into a detected phishing website is the subject matter of U.S. patent application Ser. No. 16/995,783, entitled “Systems and Methods for Protection From Phishing Attacks,” and incorporated here by reference.

It is also an object of the present invention to gather information about the code and toolchains used in a phishing website as a means of profiling the phisher. Information may be gathered about the terms, attributes and ids, used in the Javascript code as elements of the attacker's own code base. Repetitive use of these terms across different phishing websites may be attributed to the same attacker, or the same team of attackers, who may reuse the same infrastructure that automates phishing campaigns. Specific Javascript libraries may be included on a per attacker arrangement; different toolchains may package up the Javascript differently and in a very distinct way.

Numerous variations may be practiced in the preferred embodiment.

### BRIEF DESCRIPTION OF THE DRAWINGS

A further understanding of the invention can be obtained by reference to exemplary embodiments set forth in the illustrations of the accompanying drawings. Although the illustrated embodiments are merely exemplary of systems, methods, and apparatuses for carrying out the invention, both the organization and method of operation of the invention, in general, together with further objectives and advantages thereof, may be more easily understood by reference to the drawings and the following description. Like reference numbers generally refer to like features (e.g., functionally similar and/or structurally similar elements).

The drawings are not intended to limit the scope of this invention, which is set forth with particularity in the claims as appended hereto or as subsequently amended, but merely to clarify and exemplify the invention.

FIG. 1 is a flowchart depicting a method for evaluating a phishing website, according to the present invention;

FIG. 2 depicts a table of digital identity attributes.

### DETAILED DESCRIPTION OF THE INVENTION

The invention may be understood more readily by reference to the following detailed descriptions of embodiments of the invention. However, techniques, systems, and operating structures in accordance with the invention may be embodied in a wide variety of forms and modes, some of which may be quite different from those in the disclosed embodiments. Also, the features and elements disclosed herein may be combined to form various combinations without exclusivity, unless expressly stated otherwise. Consequently, the specific structural and functional details disclosed herein are merely representative. Yet, in that regard, they are deemed to afford the best embodiments for purposes of disclosure and to provide a basis for the claims herein, which define the scope of the invention. It should also be noted that, as used in the specification and the appended claims, the singular forms “a”, “an”, and “the” include plural referents unless the context clearly indicates otherwise.

Use of the term “exemplary” means illustrative or by way of example, and any reference herein to “the invention” is not intended to restrict or limit the invention to the exact features or steps of any one or more of the exemplary embodiments disclosed in the present specification. Also, repeated use of the phrase “in one embodiment,” “in an exemplary embodiment,” or similar phrases do not necessarily refer to the same embodiment, although they may. It is also noted that terms like “preferably,” “commonly,” and “typically,” are not used herein to limit the scope of the claimed invention or to imply that certain features are critical, essential, or even important to the structure or function of the claimed invention. Rather, those terms are merely intended to highlight alternative or additional features that may or may not be used in a particular embodiment of the present invention.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, some potential and preferred methods and materials are now described.

The present invention provides “enhanced attribution” of phishers, or organized teams of phishers, and assessment of the level of danger posed by their phishing campaigns aimed at ordinary users. This may be accomplished by analyzing the contents of phishing websites the phishers have deployed. Each instance of a phishing website offers valuable data from which an analysis of the displayed input terms generated by the phisher's code may reveal the danger the site poses, and an evaluation of the phisher or phishing team who composed that site. The profiling of phisher behavior is useful as advanced threat intelligence to aid in predicting whose website they will next target as a source of a spoofing and phishing campaign. Information that reveals motive and intent may be useful to law enforcement for investigating organized phishing teams who target, for example, financial intuitions or medical websites.

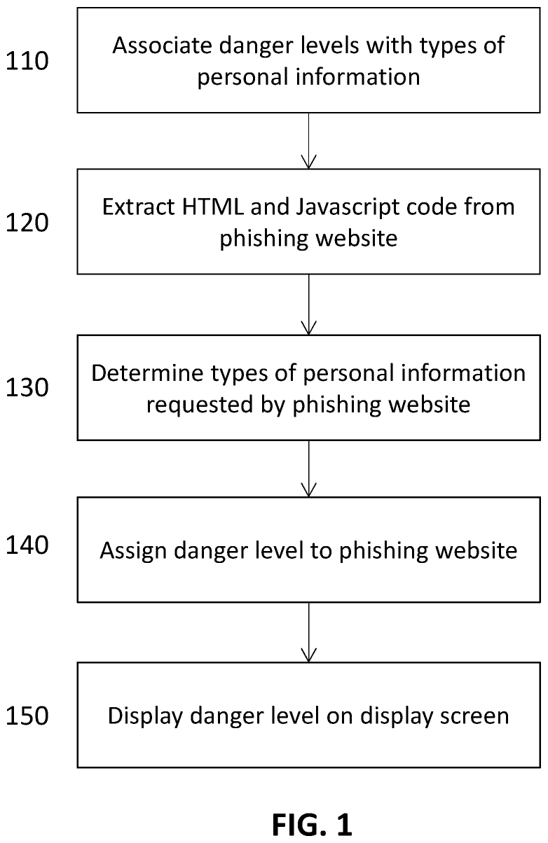

FIG. 1 depicts a flowchart showing an exemplary method for evaluating a phishing website according to the present invention. The method may be performed by machine executable code stored in non-transitory computer memory and executed by one or more processors of a computer or computer system. At Step (110), two or more danger levels may be associated with sets of types of personal information. At Step (120), the HTML and Javascript code from the phishing website may be extracted. At Step (130), from the HTML and Javascript code, one or more types of personal information requested by the phishing website may be determined from the output strings and text displayed by a browser rendering the phishing website and/or associated terms or variable names in the Javascript code that are used to store information requested by the phishing website. At Step (140), the phishing website may be assigned to a danger level associated with the personal information. At Step (150), the danger level may be displayed on a display screen.

A system in accordance with the present invention may include a browser that displays a banner warning when the URL of a viewed or requested website points to a suspicious phishing website, determined based upon a rating of the danger of the site. The warning may include a level of danger as described further below. Additionally or alternatively, the warning may be displayed in a popup window on a display. Additionally or alternatively, the warning may be displayed as a notification on a display.

The level of danger posed by a phishing website may also inform the design of mitigation strategies and the speed of response taken to protect users from that site. The speed of response is crucial. Studies show a website nets 50% of their victims under 10 hours, far shorter than a takedown request is typically processed, if ever.

One mitigation strategy is to stuff decoy information at the phishing website immediately when it is detected. The first important task is to know what decoy information to generate in order to provide it to the phishing website correctly. Otherwise, the data will not be taken up by the phisher. In the context of phishing mitigation, the problem is relatively straight forward. The phisher is after identity information, which is generally easy to generate. Stuffing a phishing website with believable decoy information devalues what the phisher may have stolen, thereby changing the economics of the phishing attack at its core.

A phishing site may be rated at different levels of “danger” with regard to the sensitive personal information sought to be stolen. An exemplary rating scheme of “Significant,” “High,” and “Extreme” levels of danger may be used to delineate phishing websites. Significant level of danger may signify a site that gathers contact information for subsequent targeted attacks, but does not trick the user into provide particularly sensitive information. For example, phishing websites that pose as a coupon site may gather email addresses, without passwords, for use by the phishers in later campaigns, or for sale on the black market for future phishing campaigns by other phishers. Similarly, phishing by an invitation that only requests a user's mobile number for future targeted Smishing campaigns.

A High level of danger may indicate a phishing website that gathers user credentials which provide access to some valuable resource, account or service. The phishing website may convince a user to provide their email address and password which provides access to their banking website, and hence, access to their bank account.

An Extreme level of danger may indicate a phishing website designed to gather a victim's sensitive Personally Identifiable Information (PII). The PII may be used to steal the victim's identity and create new accounts using the stolen identity. PII loss is the most dangerous a user can experience, often costing significant financial losses and years of effort to deal with identity loss. Some phishing websites that are spoofed, or cloned from a legitimate source, request PII well beyond what the original legitimate site requires. For example, a user's banking website is not likely to require their social security number each time the user logs on. A phishing site spoofing the user's bank may do so and pose an extreme level of danger to the user.

For each level of danger assigned to a phishing site, a system in accordance with the present invention can determine what the phishing site is designed to steal from a list of identity information associated with modern digital identities. The evaluation is accomplished by extracting all content from the phishing site and analyzing the HTML and Javascript code, especially those portions developed by the phisher. In particular, the output strings and text generated by the phisher's code displayed by the browser rendering the website.

Note that this three-level ranking may be expanded to other gradations as a particular context may require. Without loss of generality, evaluating phishing websites in terms of three levels of danger provides a grounding example for what these other finer-grained analyses might be. For example, some phishing websites may deliver dangerous malware to the endpoint device of their victim causing a persistent foothold and turning their machine into a bot in their network, itself causing harm to other machines on the internet. This might cause a different level of danger not captured solely by identity attributes and information alone. The methodology can easily be extended to incorporate other attributes of phishing sites as the context may require, such as the kind of account information they target, typical banking accounts or bitcoin accounts.

Different Sensitivities of Personally Identifiable Information (PII)

A rating scheme in accordance with the present invention may distinguish between a set of digital identity attributes that are deemed highly sensitive and others less sensitive. Different identity attributes, or combinations of identity attributes, may be assigned to different levels of danger as the context may require. Each phishing website analyzed may be assigned the appropriate level of danger based upon this assignment. This technique is referred to herein as “Rating A Phishing Site” (RAPS).

It is instructive to consider what a phisher may be after and the kind of information they steal via their phishing campaigns and crafted websites. Sensitive personally identifiable information may include, for example:

Employee personnel records and tax information, including

Social Security number and Employer Identification Number

Passport information

Medical records covered by HIPAA laws

Credit and debit card numbers

Banking accounts or Bitcoin/Wallet Accounts

Electronic and digital account information, including email addresses and internet account numbers

Passwords

Biometric information

School identification numbers and records

Private personal phone numbers, especially mobile numbers

If a phishing web site analysis reveals that some number of these digital identity attributes is gathered, that site is considered extremely dangerous. Other phishing websites may be deemed highly dangerous but not extreme, if some subset of non-sensitive information is gathered. Non-sensitive information is generally publicly available information and includes:

Birth dates

Place of birth

Addresses

Religion

Ethnicity

Sexual orientation

Business phone numbers and public personal phone numbers

Employment-related information

The combination of certain public information may also constitute highly sensitive PII and hence cause a phishing website to be evaluated as extremely dangerous, hence a rating scheme should account for the total amount of PII requested by the phishing site. Other phishing websites may be deemed to be of significant danger, but neither highly or extremely dangerous if they are limited to tricking users into providing non-sensitive information. A single email address without a password is troublesome, but only poses a significant threat to the user's future spam folder.

Digital Identity Attributes

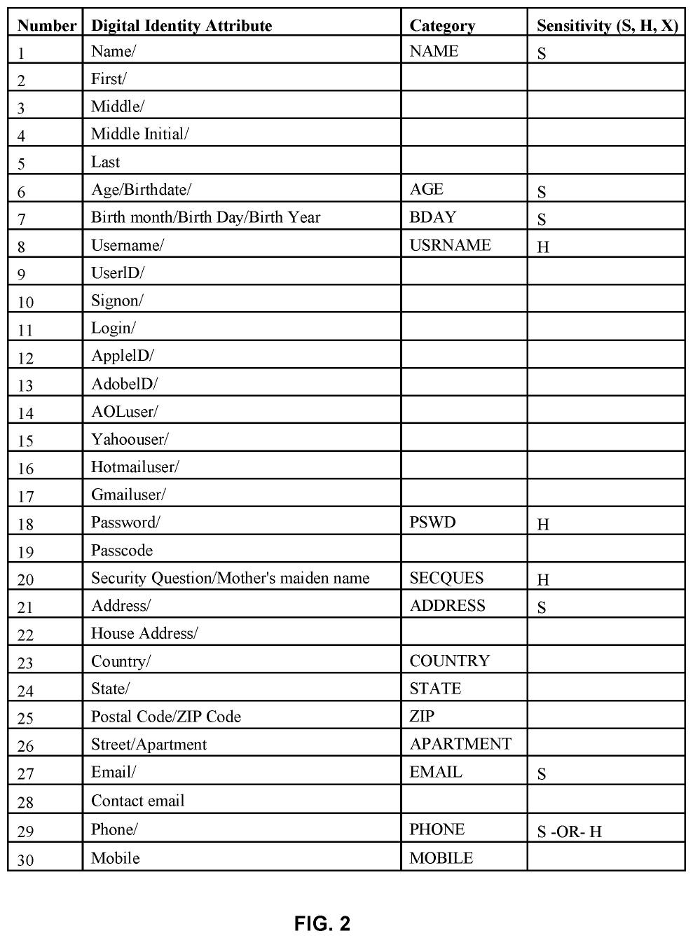

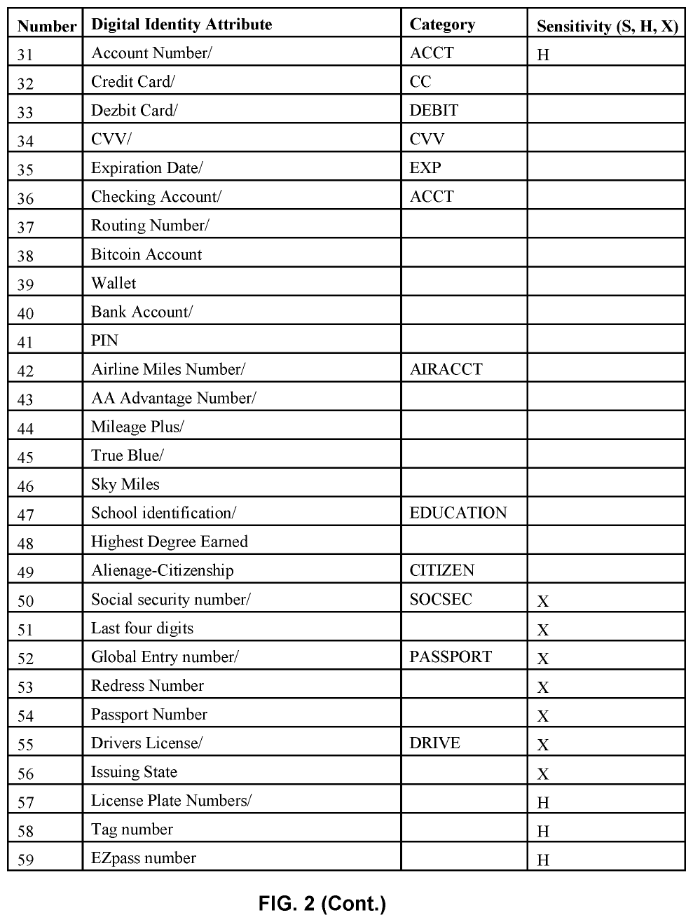

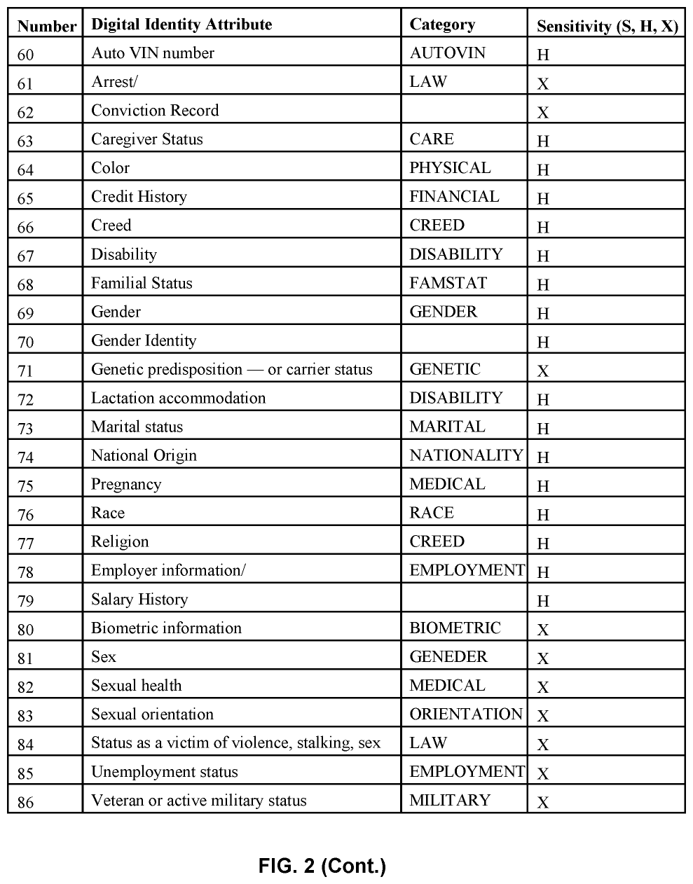

A RAPS system may make use of the digital identity attributes in the table shown in FIG. 2 when analyzing the content of phishing websites. There are undoubtedly other attributes that might be employed. Items with a trailing “I” indicate a grouping associated with the consecutive terms for some particular property. For example, items 1 through 5 pertain to a person's name and are typically requested by “First, Middle, Last” or some variation such as “Given, Middle Initial, Last”. Likewise, a user's login name might be “Username,” or “Logon,” as represented in items 8 through 17. A simple categorization of a group of identity attributes appears in the second column.

Phishing Website Javascript Analysis

A RAPS system may be designed to analyze the Javascript code extracted from a known phishing site and extract two distinct sets of “terms” or “tokens” used in the analysis of assigning danger levels to a phishing website. A phisher is typically after digital identity information which is provided by a human user who reads a rendered webpage. The information the phisher seeks is easily identifiable by focusing on the html input/tags requested of the user (typically “text”) and the associated terms or variable names used in the code to store the user's provided information. This context constrains the task of analyzing the phishing website html and JavaScript code to easily manageable proportions.

A few sets of terms or names the code provides may be distinguished: (1) attacker variable names; (2) victim viewed terms; and (3) form features.

(1) Attacker Variable Names: Javascript attributes and ID's, essentially “variable” names in a programming language, used by the code writer. These attribute/id's reveal what information the victim visitor to the website provides in responses to a displayed message when the phishing webpage is rendered. At times, the code may employ standard Javascript code and terms. For example, j username and j password are standard names in the Java Servlet specification. The attacker, however, may introduce other terms for other input value they have devised themselves to gather from the victim visitor to their website.

(2) Victim Viewed Terms: The displayed tokens or terms presented to the user when their browser executes the Javascript code which dynamically generates the displayed tokens. This constitutes the terms viewed by the user either in an input box or field. These terms may be revealed by executing the Javascript code and are likely to be commonly used terms as presented in the list of digital identity attributes appearing above.

(3) Form Features: specific features which make up the input form. For example, (a) Have the elements been edited from the cloned version?; (b) Is it embedded on the page or in an iframe?; (c) Is the visible content manipulated by css or js?; (d) Does it contain image content?; (e) Is the post action being redirected offsite or within the page?; (f) How many hidden form elements?; and/or (g) Does the form provide mouse over, suggestions, error correction on the input? These feature sets of tokens or terms are used to identify the personal or sensitive information the website gathers from a victim visitor.

Displaying Results to Users

The outcome of an analysis of a phishing website in real time may be displayed to security personnel responsible for the web security of their organization, and/or to end users. In the former case, a straightforward labeling of a phishing website with its level of danger may be added to already existing security dashboards. This additional information may benefit the real time response choices they make. For example, a phishing site that mimics their corporate web presence that is deemed a significant danger might simply get a take-down request. A site deemed highly dangerous may require a takedown operation and a reporting to various filters and threat intel companies. An extremely dangerous phishing site might require the same responses, augmented with an active decoy stuffing operation to thwart the phisher's attempts at doing great harm to the organization's customers. These choices are better informed when the phishing website is better categorized.

For an end user, the rating scheme might be presented with a browser banner driven by a browser extension that automatically tests sites for PII input fields. Recently, Google announced a feature of its Chrome86 browser to truncate the URL displayed to users revealing only the domain name, in an attempt to increase the likelihood user's will not fall prey to phishing. This feature might be augmented with a standard risk ranking color coding of the domain name. For example, black for significant risk, orange for high risk, and red for extremely dangerous sites.

Phisher Profiling

One approach to profiling attacker behavior may be derived from a detailed analysis of their programming style. Stylometry is a well-studied field ranging from author identification techniques to a biometric modality for active authentication. One may, for example, extract the Javascript code from a phishing website and compute the n-gram distribution of the code when analyzed as text. The gram may be n consecutive characters or bytes of the code, or n consecutive terms or keywords in the code. In either case, this approach is fraught with error and complexity when large amounts of data is necessary to implement what is essentially an author identification task. In this context, the problem may be significantly reduced in complexity by analyzing the variable names used in the phisher's own code.

The attacker variable names are useful in clustering commonly used terms across different phishing sites and provides an indicator that a phisher is reusing code over multiple phishing sites they create. Hence, an attacker profile may be created by finding and storing their commonly used variable names associated with a set of phishing sites determined by a clustering algorithm. This data constitutes ground truth data to model the attacker's behavior, essentially a profile useful for “enhanced attribution,” or for future defensive purposes in identifying a “known attacker.” They are “known” by their profile. A history of the attacker may reveal their intent, and provide a means to infer their future attack behavior. For example, do they favor financial institutions, or are they directed more towards pharmaceuticals?

Both the attacker variable names and the victim viewed terms identify what set of PII the website is attempting to steal. The set of PII attributes is identified in the (partial) above list of digital identity attributes. This information is necessary in order to identify the set of decoy PII data to generate and stuff into the Phishing site, as described fully in U.S. patent application Ser. No. 16/995,783, entitled “Systems and Methods for Protection From Phishing Attacks,” incorporated here by reference.

Table 1 below displays a set of example attacker variable names extracted from the Javascript code in a sample of X known phishing sites, along with a frequency count of the number of occurrences of those terms in the sample.

TABLE 1

| | |
|---|---|
| Email | 2413 |
| contact email | 12 |
| email | 268 |
| adobeID | 13 |
| aoluser; hotmailuser; yahoouser; gmailuser; otheruser | 3 |

Table 2 below similarly presents a small set of common terms rendered by the browser and viewed by the victim. They are examples of displayed terms that seek input from the victim user. These terms may be extracted from the Javascript code and html input text strings. The Javascript is executed to reveal what the user will see.

TABLE 2

Social Security
User Name
Email
Mobile
Account
Address
Credit Card Number

Data Sets for Analysis

Data gathered from phishing websites permits a longitudinal study to determine how phishing sites have changed over time, and whether there is an increase in the level of danger associated with the sites over time. The data may also be used to test and evaluate the ability to model phisher behavior.

While the invention has been described in detail with reference to embodiments for the purposes of making a complete disclosure of the invention, such embodiments are merely exemplary and are not intended to be limiting or represent an exhaustive enumeration of all aspects of the invention. It will be apparent to those of ordinary skill in the art that numerous changes may be made in such details, and the invention is capable of being embodied in other forms, without departing from the spirit, essential characteristics, and principles of the invention. Also, the benefits, advantages, solutions to problems, and any elements that may allow or facilitate any benefit, advantage, or solution are not to be construed as critical, required, or essential to the invention. The scope of the invention is to be limited only by the appended claims.

What is claimed is:

1. A method for evaluating a first phishing website that may be accessed by a user, comprising:
associating each of two or more danger levels with a set of types of personal information;
extracting the HTML and Javascript code from the first phishing website;
determining from the HTML and Javascript code one or more types of personal information requested by the first phishing website from the output strings and text displayed by a browser rendering the first phishing website and associated terms or variable names in the Javascript code that are used to store information requested by the first phishing website; and
assigning to the first phishing website a danger level associated with the personal information.
displaying the danger level on a display screen.

2. The method of claim 1 wherein the outcome is displayed as a banner on a website.

3. The method of claim 1 wherein the outcome is displayed in a popup window.

4. The method of claim 1 wherein the outcome is displayed as a notification.

5. The method of claim 1 further comprising entering decoy information at the first phishing website.

6. The method of claim 5, wherein the decoy information is determined based on Javascript code extracted from the first phishing website

7. The method of claim 1 further comprising computing an n-gram distribution of the Javascript code when analyzed as text.

8. The method of claim 7 further comprising extracting the Javascript code from a second phishing website.

9. The method of claim 8 further comprising computing an n-gram distribution of the Javascript code from the second phishing website.

10. The method of claim 9 further comprising using a clustering algorithm to identify commonly used variable names associated with the first phishing website and the second phishing website.

11. The method of claim 10 further comprising entering decoy information at the second phishing website.

12. The method of claim 11, wherein the decoy information is determined based on Javascript code extracted from the second phishing website.
